(19) United States
(12) Patent Application Publication
(10) Pub. No.: US 2015/0052006 A1
(43) Pub. Date: Feb. 19, 2015

(54) METHOD AND SYSTEM FOR PRESENTING AND SELECTING GARMENTS FOR PURCHASE ON A MOBILE DEVICE

(71) Applicant: Moda Operandi, Inc., New York, NY (US)

(72) Inventors: Steve Sanchez, San Francisco, CA (US); Sebastian Mirabile, New York, NY (US); Jon Kowalski, New York, NY (US); Khalid Meniri, New York, NY (US); Elizabeth Cordry, New York, NY (US)

(73) Assignee: Moda Operandi, Inc., New York, NY (US)

(21) Appl. No.: 13/968,562

(22) Filed: Aug. 16, 2013

(51) Int. Cl. G06Q 30/06

(52) U.S. Cl. CPC G06Q 30/0633; G06Q 30/0643
USPC 705/26.8

(57) ABSTRACT

This invention discloses a novel system for displaying fashion designs presented at runway shows in order that retail customers may purchase the designs directly and as soon as they become available after the runway show. The system includes a device application intended to be operated on a user's portable computing device for displaying images, receiving selection input from the user and conducting purchase transactions and fulfillment through the system. The system includes a novel system of permitting a user to select fashion looks and to be automatically alerted when those looks become available for purchase. For high demand items, the system has a priority queuing system that automatically manages the selection of users given the opportunity to purchase the high demand item.

### FIELD OF INVENTION

This invention relates to the sale of clothing and related merchandise in a manner that provides purchasers the ability to purchase such products early in the fashion cycle either directly from the design house that produces the merchandise or from a distributor that obtains the merchandise from the design house or its authorized manufacturers. The system provides a mechanism whereby fashion shows may be electronically distributed to users who can then select among fashion designers and the looks presented by the fashion designers in order to purchase the garments and related merchandise.

### BACKGROUND

Traditional fashion shows are presented in person, in the form of what is referred to in the art as a runway show. Buyers for traditional retail stores attend these shows in order to select what fashions they seek to buy as inventory for the store. However, end retail customers have to purchase these goods from the retailer. The invention provides an electronic means for retail customers to tap into this process so as to place retail orders electronically from the runway show stage of promotion in parallel with the typical retail distribution process. Typically, the item presented at the runway show is not yet available. But the system organizes the pre-purchasing of these merchandise items at a retail level. In some cases the merchandise may be purchased prior to its manufacture based simply on its appearance in a runway show.

### DESCRIPTION OF THE FIGURES

FIG. 1. Data structure schematic for a fashion designer and at least one Look.

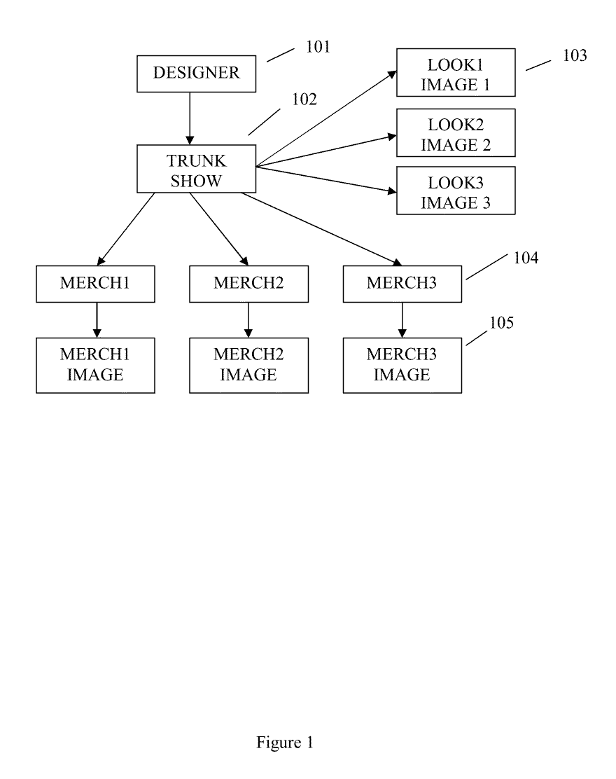

FIG. 2. Data structure schematic for a merchandise item associated with a Look.

FIG. 3. Data structure schematic for a designer that has multiple Looks.

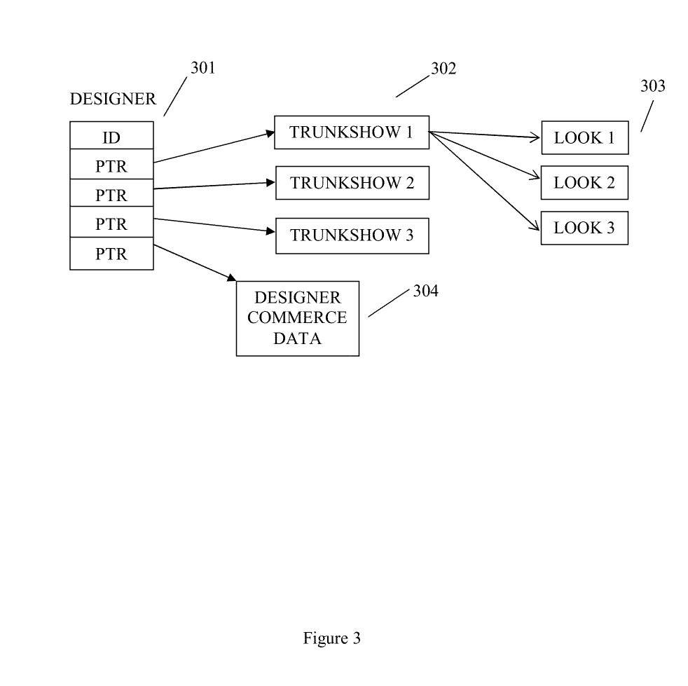

FIG. 4. Basic system architecture.

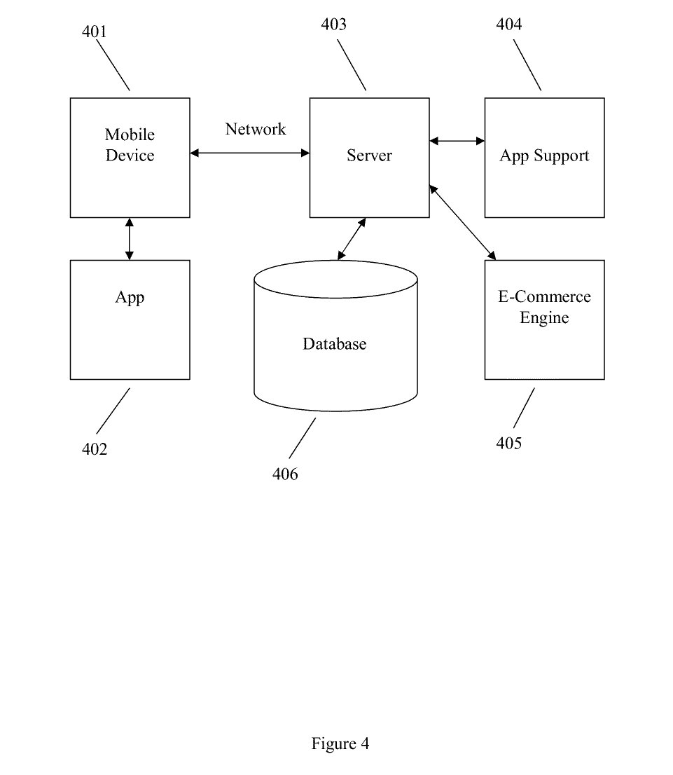

FIG. 5. Flow chart for display of Look images.

FIG. 6. Flow chart for selection of Look for Watchlist.

FIG. 7. Flow chart for Look selection for purchase, and availability notification.

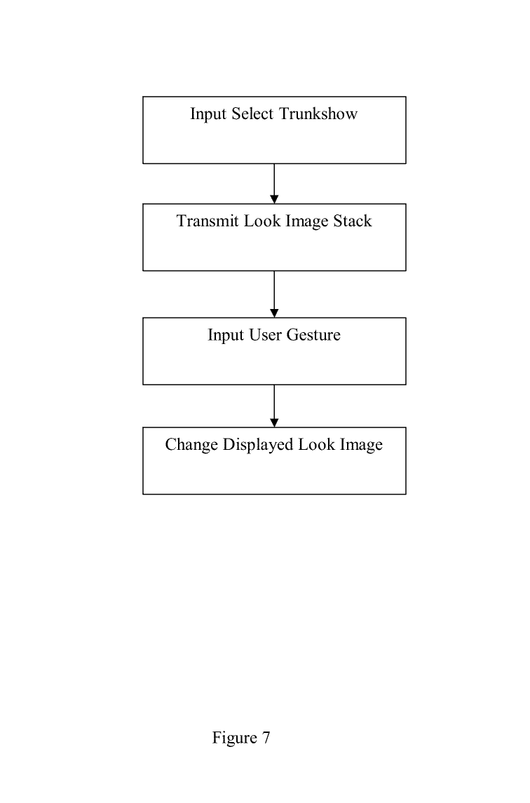

FIG. 8. Data structure schematic for a user, with a watchlist.

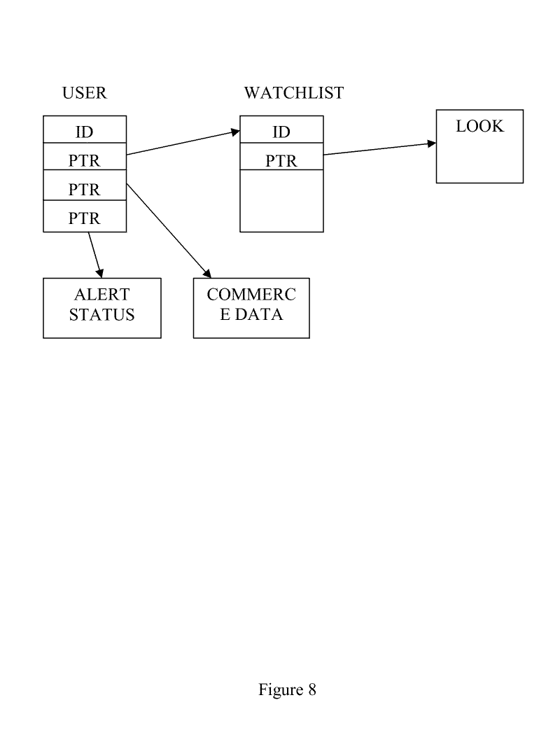

FIG. 9. Example pictorial embodiment of the App showing a look.

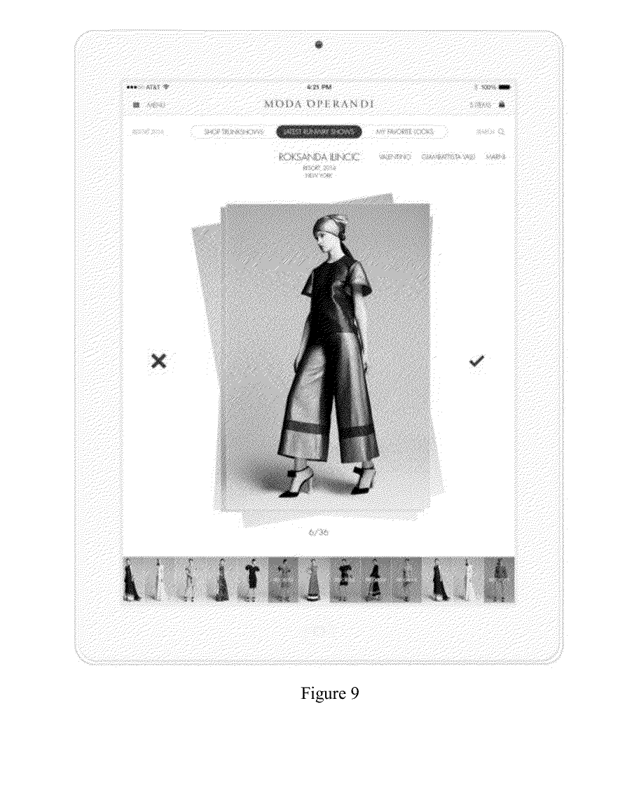

FIG. 10. Example pictorial embodiment of the App showing a look with related merchandise.

### DETAILED DESCRIPTION OF THE PREFERRED EMBODIMENTS

The system operates on one or more computers, typically one or more file servers (403) connected to the Internet and also on a customer's computing device (401). A customer's device can be a personal computer, mobile phone, mobile handheld device like an Android™, Blackberry™ or iPhone™, or any other kind of computing device a user can use to send and receive data messages and display images. The device executes a computer program, referred to as an App (402) that is adapted to provide the local functionality of the system on the user's device. The server (403) has a database (406) operatively connected to it that centrally stores certain data associated with the operation of the system. The server system also has two components, the App Support module (404), and the e-commerce engine (405). The App Support component is adapted to interface the server system with the app running on the user's device. The E-commerce engine is adapted to receive data from the system and cause purchase transactions to be executed with the typical updating of bookkeeping data, shipping data and the like that is known in the art.

The system organizes the data associated with fashion designers in a hierarchy that is designed to facilitate the presentation and selection of garments and related merchandise for sale. In this fashion the data structures are adapted so that each fashion Designer (101) has at least one Trunkshow (102), which is comprised of at least one Look. The Look has at least one image associated with it (103). In addition, the Look has component merchandise items (104). Each merchandise item has its own related image (105). In an example embodiment, the Look (103) may comprise an image of a model wearing a dress, holding a handbag and wearing shoes. The dress, handbag and shoes are three merchandise items associated with the look. There may be more than one merchandise image for each item of merchandise, for example, the model with a front view, side view and rear view. The look is associated with a Designer, because the Designer selects the merchandise making up the Look.

Each item of merchandise has a data structure associated with it that relates the merchandise to its context. An item of merchandise (201) has an identifier ID and also is related to its Look (202) and its merchandise image (205). In addition, the merchandise item (201) is associated with its commerce data (204). The commerce data includes pricing, types (e.g. color, sizes and the like) and availability for each type. The availability data can take two forms. In one embodiment, availability is a value that indicates whether the merchandise item has arrived into inventory and can be shipped to the customer that purchased it. In another embodiment, availability is a value that indicates that the merchandise item comprising a Look is available to be purchased at all. In this embodiment, the Look may be distributed to the App for approval by the customer, and such approval registered in the customer's watchlist, but the merchandise items comprising the Look may not be available for purchase until the Designer associated with the Look has caused the appropriate commerce data to be input into the system. Other data, including manufacturing source and the like are included in the commerce data (204). In one embodiment, the commerce data includes pricing associated with different geographical regions so that a Designer can be sure that the electronic purchase of merchandise is not competing with the retail pricing in a given geographical region.

Each Designer participating in use of the system is represented in the system and has an associated data structure. (301) A Designer has an identifier ID and also references to at least one Trunkshow (302) that the Designer has assembled. The Trunkshow contains at least one Look (303). In addition, the Designer has a reference to the Designer commerce data (304). This can include the name and address of the Designer and other contact information, data related to purchase order entry and shipping information.

Each user operating the App has an associated data structure on the server. The user (501) has a User ID. In addition, the user has a Watchlist (502), which is the list of Looks that the user has selected as being of interest for purchase. In addition, the user has an associated Shopping Cart (503), which contains references to merchandise that the user has selected for purchase. The user also has user commerce data, which can include name, address, shipping address, credit card information, gender, and other data useful for completing fulfillment of the purchase transaction.

In one embodiment, the system is adapted to present the Looks to the user. In this embodiment, the system transmits to the device at least one Look image associated with at least one corresponding Designer. A collection of Looks is referred to as a stack of Look images that can comprise the Trunkshow. In one embodiment of the App, each image in the stack is used to create the background of the fully presented top image in order to make the App appear to look like a stack of actual photographs. In response to the user's input into the App, the user can move to the next image in the series. In one gesture, the user simply discards the image. In the other gesture, the user selects the Look to be input into the user's Watchlist data structure. When this gesture is received by the App, the App causes the user device to transmit to the server a data message representing the selection of the Look so that the user's Watchlist on the server is updated. This may be accomplished by the App transmitting the Look ID and the User ID in a data message. In one embodiment, the LOOK ID may be an arbitrary number associated with an image received from a photographer of a runway show. As a result, the system may only have the image, and the generated Look ID. The system can then be updated to associate a Designer with the Look ID. However, at this point, the availability value is still null because the Designer may not have provided data to input any commerce data for the merchandise comprising the Look. At some point, the Designer provides commerce data for the Look. This may include detail about the component merchandise, including sizing, pricing and other data, as well as additional merchandise images. At some point, there is sufficient information for at least one merchandise item comprising the Look to be deemed available for purchase. At that point, the system detects which users have that Look ID associated with their Watchlist. On the basis of that determination, the system transmits to those users a data message representing an alert message that the Look is available for purchase.

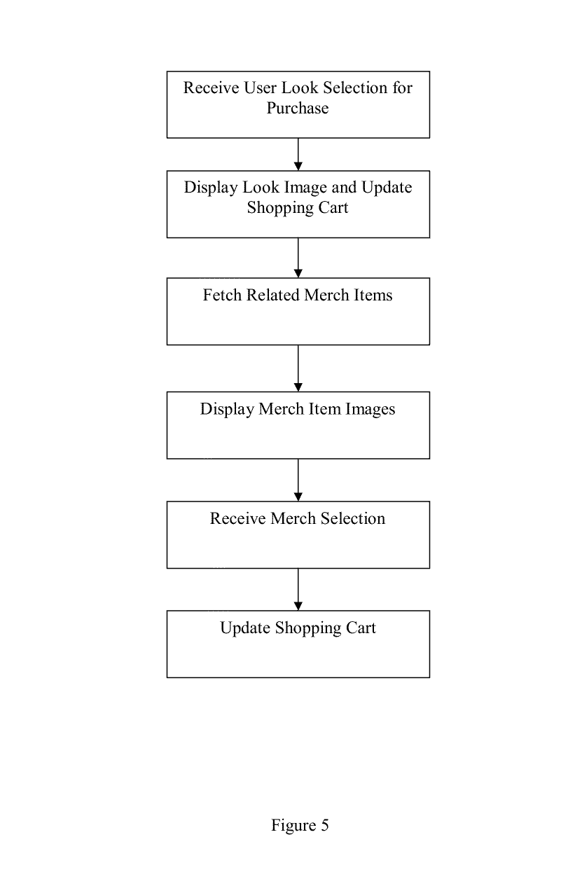

In another embodiment, the selection of the Look causes the App to request from the server the remaining Merchandise images that comprise that selected Look. See FIG. 5. The user device then transmits a data message to the server comprised of the User ID and the Look ID, and the server responds by transmitting the remaining Look images. As a result, the App is enabled to display the Look images on the user device. In yet another embodiment, the server also transmits the Merch images associated with the Look. As a result, the App is able to locally display the Merch images in a context with the Look.

In one embodiment, the server stores data associated with each Look that are selection data by particular individuals of influence. For example, the Look data structure may include data indicating that a well-known fashion editor has selected or approved the Look. As a result, when the App transmits the Look ID to the server, the server can determine if that Look has been favorably selected by the other particular user. If so, the server can transmit this information back to the user device in order to cause the App to display this information to the user. In yet another embodiment, the server may receive from the many users of the system data indicating whether for a particular Look, that user liked it or did not, based on their individual selection. This data can be aggregated to indicate the percentage of users that liked the Look. This data can then be transmitted out to all users so that when viewing the Look, they can see the percentage of users that so-far have liked the Look. Other aggregated statistical results may be derived from the individual selection data and transmitted out to the users.

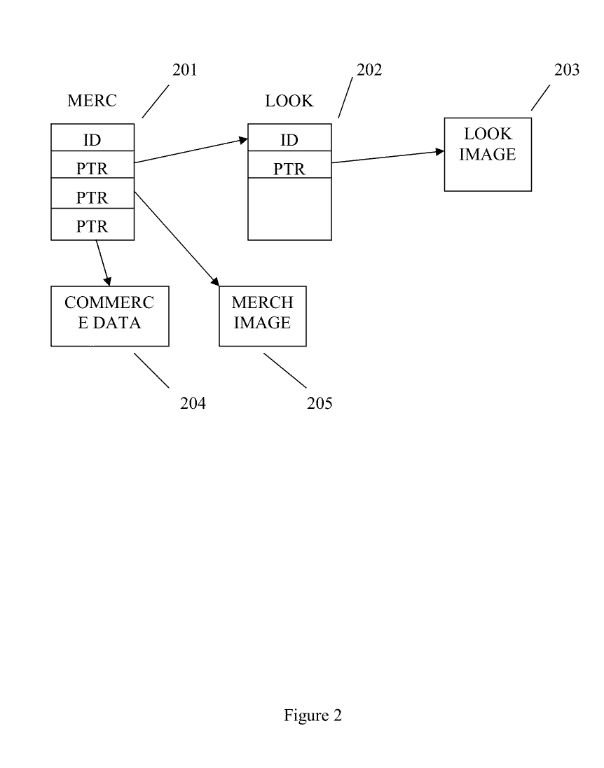

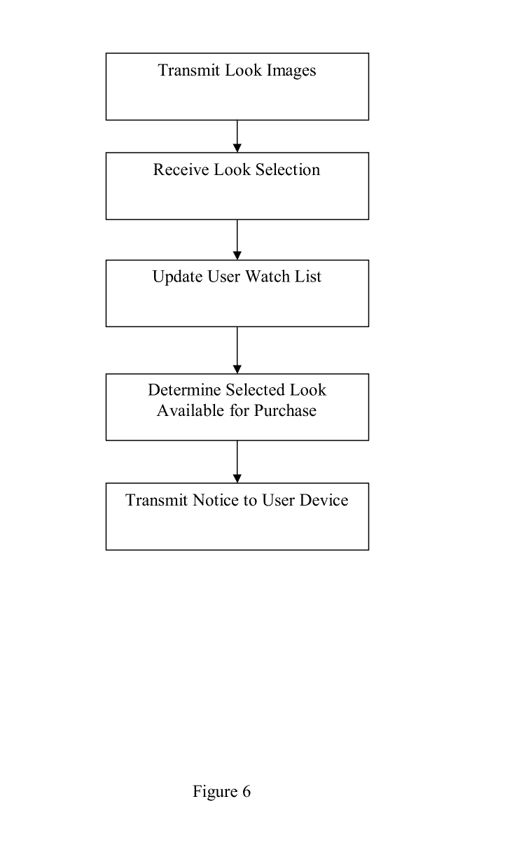

In the preferred embodiment, the user's Watchlist is comprised of references to Looks that the user has selected. The Looks are associated with merchandise items and the merchandise items have associated commercial data, including the product availability. FIG. 2. The server has a database that is updated periodically including by updating the availability data associated with the merchandise. This may be accomplished by the E commerce engine. As a result, the App module can determine for each user, whether any Looks present on the user's watchlist have become available for purchase. See FIG. 6. As noted above, a Look may be added to a Watchlist prior to its availability. As a result, if the Look becomes available for purchase, an alert message is transmitted to the user's device in order to cause the App to display that information on the user's display, or alternatively, to cause a sound to be emitted by the device. In pseudo code:

(If userID.watchlist.lookID.merchID.availability=1) then {transmit(alert, userID, LookID)}

In another embodiment, the user can inspect the contents of their watchlist. In this embodiment, the user can scroll through the Look images associated with the entries of the watchlist. In addition, the server can determine the related merchandise items and transmit these individual images down to the App for display with the Look. In one embodiment, the display screen presents the Look images in a stack that can be selectively displayed by means of the user gesturing to the left or right of the stack, thereby cycling through the display of Looks, while at the bottom of the screen, the merchandise images that comprise the Look are displayed individually.

In yet another embodiment, the user may select Looks appearing in their Watchlist for purchase. In this embodiment, the user activates the MerchID for entry into the user's Shopping Cart. The App causes the user device to transmit a data message to the server comprised of the UserID and the MerchID associated with the selected merchandise. The server stores this information in the Shopping Cart data structure. In addition, the server can determine by inspecting the MerchID.availability entry, whether that item may be shipped.

Typically, the item presented at the runway show is not yet available for shipping because the design is so new that it has not gone into full production. But the system organizes the pre-purchasing of these merchandise items at a retail level. In this embodiment, the Ecommerce engine executes a transaction to cause the user to pay at least part of the purchase price of the merchandise item. As a result, the Ecommerce engine now tracks that the merchandise item, via the MerchID and the User ID are given a position in a queue for delivery as the inventory for the item arrives from the Designer, or their designated manufacturer. The Ecommerce engine can issue an order to the Designer using the MerchID, or alternatively, it can map the MerchID to the Designer's product SKU and place the order. Once the items arrives from the Designer, the Ecommerce engine reviews the delivery queue associated with the MerchID to see which userID is next in the queue for delivery. The queue may be a list data structure associated with the MerchID. At this point, the Ecommerce engine will execute the purchase transaction for the remaining balance owed by the user and ship the product in accordance with the commerce data associated with the userID. In addition, the server will transmit a data message to the user's device so as to cause the App to display or otherwise alert the user to the delivery of the purchased merchandise.

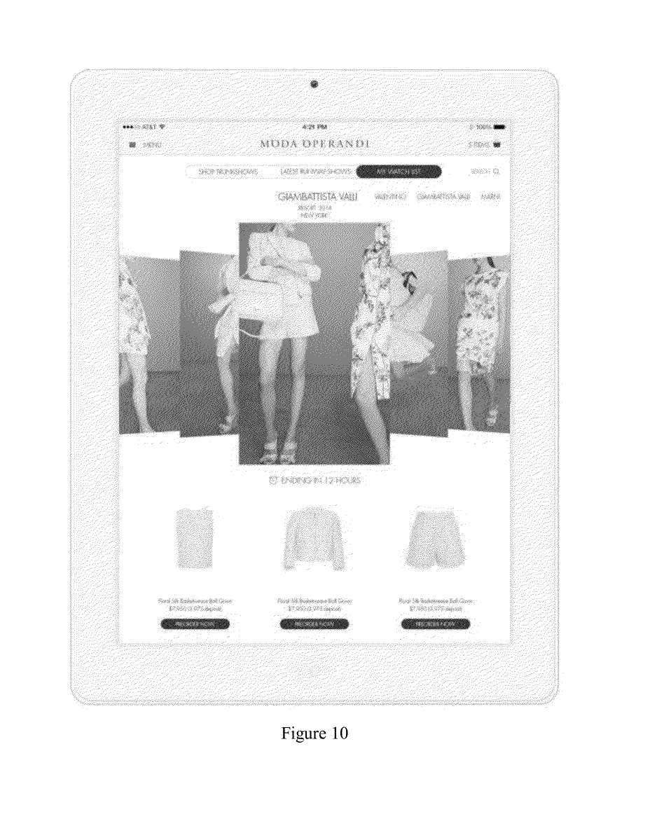

The App interacts with the Shopping Cart mechanism so that when a Look is selected, the purchase screen is displayed along with pictures of the component merchandise. These component merchandise can be selected for purchase. See FIG. 10. The App then causes the user device to transmit a request to the server to transmit down the related merchandise images. These are then displayed in the purchase screen as well. The App is adapted to operate so that if the user selects one of these merchandise items, the item is added to the shopping cart. As a result, the user can select the dress as well as the hand bag and shoes for purchase. In one embodiment, the App also receives from the server information regarding the type of the merchandise that may be purchased, for example, the size or color. This is displayed to the user so that the user may select this information. Once the selection is received, the App causes the user device to transmit to the server a data message comprising the UserID, which includes the selection data so that the user shopping cart is updated with the correct types of the merchandise selected for purchase, for example, color and size.

The system is adapted to permit off-line use of the App by the user. In this embodiment, the images of the Looks are cached locally on the user's device. In addition, the user's watchlist may be cached locally. When the App detects that the user device is back online, it can transmit to the server a data message comprising the updated watchlist. In one embodiment this message is encoded as a JSON file.

When then the system detects the availability of a watchlisted Look, it transmits an alert message out to the user device where those users have the Look in their watch list. The data message may be used by the App in a variety of ways. In one embodiment, the App, displays a visual message on part of the screen. In another, the App opens the Look image up again, and then displays text to the user indicating that it's available. In yet another embodiment, the App causes a predetermined sound to be emitted by the user device. In this embodiment, the App can run in the background on the user's device, so that they are alerted aurally while using the device display screen for some other task. The mechanism of transmitting the alert can use several forms. In one embodiment, a standard Apple™ push mechanism is used. In another, the server transmits a text message for example, over SMS.

In one embodiment of the invention, the display screen generated by the App can show a series of thumbnail images along one region of the screen that are the Looks that the user has selected. If the user has not selected any Looks, the server can transmit to the user device the identity of the Looks that are either the most popular on the system among all the users or that fit some other aggregated statistical test. When the App receives these LookID's, it will display the associated Look image thumbnails. If the App does not have a local cache copy of the Look or its thumbnail, it will transmit a request message to the server, comprised of the LookID in order that the server transmit the image back down to the user device.

In one embodiment of the invention, the system is configured so that when the user selects a Look for purchase, the purchase page displays the most popular merchandise items sold from the Designer associated with that Look. In this embodiment, the selection of the Look causes the LookID to be transmitted to the server, which then by means of the database, obtains the most popular MerchID's associated with that LookID. As a result, the MerchID's are transmitted to the App. The App uses the MerchID's to fetch the associated Merch images and then display them on the screen. In the case where the App does not have these images locally cached, the server transmits the images down to the user device.

In one embodiment, the fulfillment queue for delivery of merchandise that becomes available may be handled differently than a simple first-come first-served basis. In this embodiment, the server is able to use the database to determine which of the users who have purchased a given merchandise item, or MerchID should have priority over other such users. In this embodiment, when the user purchases the merchandise, a priority score value is calculated for that user. This is a number that may be dependent on a number of variables, including, amount of money spent on the system over a prior pre-determined period, how long the user has been purchasing from the system, the relative popularity of the items that the user typically selects for purchase. Another variable may be the historical success rate of the user in obtaining goods they have selected. These variables may be used to calculate a priority score. In one embodiment, the score is the linear combination of the values, where the coefficients are predetermined. In some cases, a good customer who has not had good luck obtaining merchandise may be given preference so as to not lose the customer's interest in using the system. Once the user's priority score is determined, then when the purchased merchandise arrives, the user whose purchase is completed is the one associated with the highest priority score.

### Operating Environment:

The system operates on one or more computers, typically one or more file servers connected to the Internet. The system is typically comprised of a central server that is connected by a data network to a user's computer. The central server may be comprised of one or more computers connected to one or more mass storage devices. A website is a central server that is connected to the Internet. The typical website has one or more files, referred to as web-pages, that are transmitted to a user's computer so that the user's computer displays an interface in dependence on the contents of the web-page file. The web-page file can contain HTML or other data that is rendered by a program operating on the user's computer. That program, referred to as a browser, permits the user to actuate virtual buttons or controls that are displayed by the browser and to input alphanumeric data. The browser operating on the user's computer then transmits values associated with the buttons or other controls and any input alphanumeric strings to the website. The website then processes these inputs, in some cases transmitting back to the user's computer additional data that is displayed by the browser. The precise architecture of the central server does not limit the claimed invention. In addition, the data network may operate with several levels, such that the user's computer is connected through a fire wall to one server, which routes communications to another server that executes the disclosed methods. The precise details of the data network architecture do not limit the claimed invention. Further, the user's computer may be a laptop or desktop type of personal computer. It can also be a cell phone, smart phone or other handheld device. The precise form factor of the user's computer does not limit the claimed invention. In one embodiment, the user's computer is omitted, and instead a separate computing functionality provided that works with the central server. This may be housed in the central server or operatively connected to it. In this case, an operator can take a telephone call from a customer and input into the computing system the customer's data in accordance with the disclosed method. Further, the customer may receive from and transmit data to the central server by means of the Internet, whereby the customer accesses an account using an Internet web-browser and browser displays an interactive webpage operatively connected to the central server. The central server transmits and receives data in response to data and commands transmitted from the browser in response to the customer's actuation of the browser user interface.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. The database may organize the data in various kinds of linked lists of varying dimension, or struct abstractions in some computer languages. However, the data may alternatively be organized in a number of tables that are related by keys, as in the form of a relational database. While the invention data structures may be described by one form, the example is not intended to be limiting or excluding other data organization types that accomplish the same purpose.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed:

1. A system for purchasing merchandise comprised of a server operatively connected by means of a data communications network to a user's device, said client module adapted to receive at least one images associated with at least one corresponding looks, to display the at least one received images on a display of the user device, to receive input from the user selecting at least one of the displayed looks, and in dependence on the received user input, to store in a watchlist data structure associated with the user, a reference to the selected look.

2. The system of claim 1 where the server is further adapted to determine whether merchandise associated with the selected look is available for purchase, and in dependence on such determination, to transmit a data message to at least one user device where such receiving user has selected such look for inclusion on such user's watch list.

3. The system of claim 1 further comprised of a database, the database configured to include at least one hierarchical data structure, said hierarchical data structure comprised of a designer, where the designer component is comprised of at least one look, where the at least one looks are comprised of at least one merchandise item.

4. The system of claim 3 where the at least one merchandise item is comprised of an image and commerce data.

5. The system of claim 3 where the look is further comprised of at least one images.

6. A method executed by a computer system comprised of a server operatively connected by means of a data communications network to a user's device, said method comprising:
Transmitting to the user device at least one look data object and associated metadata, said look object comprised of at least one image;
Displaying the at least images on the user device.

7. The method of claim 6 further comprising:
Receiving from the user a selection input of a look representing an approval;
Updating a watchlist data structure associated with the user with at least part of the metadata associated with the approved look;
Determining the availability for purchase of at least one merchandise item associated with the selected look; and
In dependence on such determination, transmitting to the user device a data message representing an alert as to the availability for purchase.
